(19) United States
(12) Patent Application Publication
(10) Pub. No.: US 2008/0030804 A1
(43) Pub. Date: Feb. 7, 2008

(54) Optical beam scanning apparatus, image forming apparatus

(75) Inventor: Yasushi Kuribayashi, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/489,782

(22) Filed: Jul. 20, 2006

(51) Int. Cl. H04N 1/04

(52) U.S. Cl. 358/484

(57) ABSTRACT

An optical beam scanning apparatus and an image forming apparatus equipped with the optical beam scanning apparatus of the present invention include: an attaching plate attached to a main body housing of the optical beam scanning apparatus; a holder attached to the attaching plate; and a laser drive board screwed to the holder, wherein the holder is provided with plural pinching portions capable of pinching the holder by means of an outside apparatus, an attachment hole used to attach the attaching plate, and an attaching screw, being in a loose fit state, to be thread coupled to the attaching plate. According to the optical beam scanning apparatus and the image forming apparatus equipped with the optical beam scanning apparatus of the present invention, it is possible to perform rotary adjustment of the light source about the optical axis with ease and at high accuracy even in a small space.

### BACKGROUND OF THE INVENTION

1. Technical Field of the Invention

The present invention relates to an optical beam scanning apparatus and an image forming apparatus equipped with the optical beam scanning apparatus, and more particularly, to an optical beam scanning apparatus configured to be capable of performing rotary adjustment of the light source about the optical axis and an image forming apparatus equipped with the optical beam scanning apparatus.

2. Related Art

An image forming apparatus of the electrophotgraphic method, such as a laser printer, a digital copying machine, and a laser facsimile machine, is equipped with an optical beam scanning apparatus that forms an electrostatic latent image on the photoconductive drum by irradiating a laser beam (optical beam) on the surface of the photoconductive drum and scanning the laser beam thereon.

Recently, in order to increase the scanning rate on the surface of the photoconductive drum, there has been proposed a method (multi-beam method) for increasing the number of laser beams scanned at a time by providing plural light sources (laser diodes) to a single laser unit. According to the multi-beam method, plural beams for respective color components (for example, yellow, magenta, cyan, and black) emitted from the corresponding light sources undergo processing in the pre-deflection optical systems, while they are combined into a single beam to go incident on the polygon mirror. The beam deflected on the polygon mirror passes through the fθ lens forming the post-deflection optical system, after which it is separated into beams of the respective color components that are irradiated onto the photoconductive drums of the respective color components.

Incidentally, it is necessary for an optical beam scanning apparatus and an image forming apparatus using plural light sources (laser diodes) to perform rotary adjustment of the light sources (laser diodes) about the optical axis to maintain a specific sub-scanning beam pitch on the photoconductive drums. To be more specific, for example, in the case of 600 dpi (Dot Per Inch), it is necessary to perform rotary adjustment of the light source (laser diode) about the optical axis to maintain 42 μm as the sub-scanning beam pitch, and for example, in the case of 1200 dpi, it is necessary to perform rotary adjustment of the light source (laser diode) about the optical axis to maintain 21 μm as the sub-scanning beam pitch. Further, it is also necessary for the light source (laser diode) to match the optical axes with the collimator lens.

Such being the case, there have been proposed various techniques for the rotary adjustment about the optical axis and the optical axis matching with the collimator lens for an optical beam scanning apparatus and an image forming apparatus.

According to the technique proposed in JP-A-2005-164997, a light source unit is formed by fixing a multi-beam light source, a collimator lens, and an aperture integrally to a base, and the light source unit thus formed is attached to the housing in an attachable/detachable manner. Also, the base is divided into a portion where the laser diode of the light source is fixed and a portion fixed to the housing, so that the position of the laser diode is fixed in a state where the rotary adjustment has been performed. This configuration enables attachment to/detachment from the housing while the light source is kept in a state where the angle of rotation has been adjusted.

In addition, according to the technique proposed in JP-A-2003-43389, a laser unit is assembled with an inclination by being rotated about the fitting portion of an optical unit before the optical unit is attached to the image forming apparatus. This configuration makes it possible to achieve a specific sub-scanning beam pitch interval by extracting only sub-scanning components at the laser spot interval, which in turn enables a specific angle to be maintained using attachment means, such as an attaching screw, after rotary adjustment of the laser unit is performed.

Further, according to the technique proposed in JP-A-2002-341272, because a BD slit and a BD sensor are formed of an integral unit, a BD detection unit is able to perform rotary adjustment of the optical unit about the center of the optical axis of the scanning lens.

Generally, by taking a tolerance of components into account, it is preferable to perform rotary adjustment about the optical axis in the optical beam scanning apparatus and the image forming apparatus in a state where all the unit components of the optical beam scanning apparatus and the image forming apparatus have been assembled.

However, when the rotary adjustment about the optical axis is performed in an assembled state, the rotary adjustment about the optical axis is normally performed by making access to the light source (laser diode) from behind because of supporting and screwing for the rotary adjustment. This requires a space to allow access to the light source (laser diode) from behind for performing adjustment, and therefore poses a problem that the units of the optical beam scanning apparatus and the image forming apparatus are increased in size.

To be more concrete, as is shown in FIG. 1, roughly speaking, a pre-deflection optical system 1-b and a post-deflection optical system 1-c are provided within a unit 1-a of the optical beam scanning apparatus. Laser units 1-d through 1-g, for example, of respective colors are disposed in the pre-deflection optical system 1-b. However, when rotary adjustment about the optical axis is performed by making access to the light sources (laser diodes 1-d through 1-g) from behind, a space to allow access in the directions indicated by arrows is necessary. The unit 1-a of the optical beam scanning apparatus therefore has to be increased as large as the unit 1-h.

As a countermeasure, a hole may be provided in the unit of the optical beam scanning apparatus, so that access is made to the light sources (laser diodes) from the outside of the unit. This countermeasure, however, requires a die of the sliding structure for the unit, which deteriorates the accuracy or increases the cost.

With the technique disclosed in JP-A-2005-164997, the light source unit can be attached to/detached from the housing while the light source is kept in a state where the angle of rotation has been adjusted. However, because attachment and detachment are performed by the positioning method, when attachment or detachment is performed, the optical axis is shifted from that of the collimator lens due to the influence of an error. This gives rise to a risk of deteriorating the performance of the optical scanning apparatus and the image forming apparatus.

The optical housing can be adjusted from the outside with the techniques proposed in JP-A-2003-43389 and JP-A-2002-341272. However, because a die of the sliding structure is required for the unit housing, the accuracy is deteriorated or the cost is increased as a result.

### SUMMARY OF THE INVENTION

The present invention was devised in view of the foregoing, and therefore has an object to provide an optical beam scanning apparatus capable of performing rotary adjustment of the light source about the optical axis with ease and at high accuracy even in a small space and an image forming apparatus equipped with the optical beam scanning apparatus.

In order to solve the problems discussed above, an optical beam scanning apparatus according to one aspect of the present invention includes: an attaching plate attached to a main body housing of the optical beam scanning apparatus; a holder attached to the attaching plate; and a laser drive board screwed to the holder, wherein the holder is provided with plural pinching portions capable of pinching the holder by means of an outside apparatus, an attachment hole used to attach the attaching plate, and an attaching screw, being in a loose fit state, to be thread coupled to the attaching plate.

In order to solve the problems discussed above, an image forming apparatus according to another aspect of the present invention is an image forming apparatus equipped with an optical beam scanning apparatus using plural light sources, wherein the optical beam scanning apparatus includes: an attaching plate attached to a main body housing of the optical beam scanning apparatus; a holder attached to the attaching plate; and a laser drive board screwed to the holder, wherein the holder is provided with plural pinching portions capable of pinching the holder by means of an outside apparatus, an attachment hole used to attach the attaching plate, and an attaching screw, being in a loose fit state, to be thread coupled to the attaching plate.

The optical beam scanning apparatus according to the firstly mentioned aspect of the present invention is provided with the attaching plate attached to the main body housing of the optical beam scanning apparatus, the holder attached to the attaching plate, and the laser drive board screwed to the holder, wherein the holder is provided with plural pinching portions capable of pinching the holder by means of an outside apparatus, the attachment hole used to attach the attaching plate, and the attaching screw, being in a loose fit state, to be thread coupled to the attaching plate.

Regarding the image forming apparatus according to the secondly mentioned aspect of the present invention; in an image forming apparatus equipped with an optical beam scanning apparatus using plural light sources, the optical beam scanning apparatus is provided with the attaching plate attached to the main body housing of the optical beam scanning apparatus, the holder attached to the attaching plate, and the laser drive board screwed to the holder, wherein the holder is provided with plural pinching portions capable of pinching the holder by means of an outside apparatus, the attachment hole used to attach the attaching plate, and the attaching screw, being in a loose fit state, to be thread coupled to the attaching plate.

### BRIEF DESCRIPTION OF THE DRAWINGS

In the drawings:

FIG. 1 is an explanatory view used to describe a manner in which a unit in an optical beam scanning apparatus and an image forming apparatus in the related art is increased in size;

FIG. 2 is a side view showing the configuration of an image forming apparatus incorporating an optical beam scanning apparatus to which the present invention is applied;

FIG. 3 is a view showing the detailed configuration of the optical beam scanning apparatus of FIG. 2;

FIG. 4 is another view showing the detailed configuration of the optical beam scanning apparatus of FIG. 2;

FIG. 5 is an explanatory view used to describe a method for performing rotary adjustment of a light source by making a part of optical units into a separate piece;

FIG. 6 is a view showing an example where a part of the optical units are made into a separate piece;

FIG. 7 is a view showing the detailed configuration of a holding member of FIG. 6;

FIGS. 8A and 8B are, respectively, a plan view and a front view showing the configuration when an outside apparatus is attached to the holding member;

FIG. 9 is a view showing another example where a part of the optical units are made into a separate piece;

FIG. 10 is a view showing still another example where a part of the optical units are made into a separate piece; and

FIG. 11 is a view showing still another example where a part of the optical units are made into a separate piece.

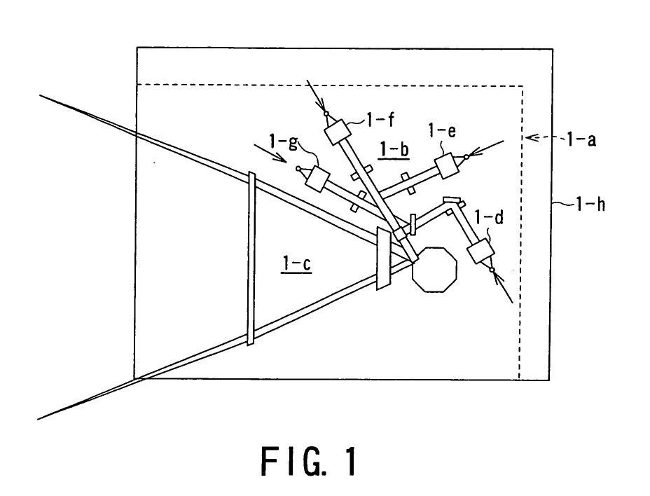

### DETAILED DESCRIPTION OF PREFERRED EMBODIMENTS

Hereinafter, embodiments of the present invention will be described with reference to the drawings.

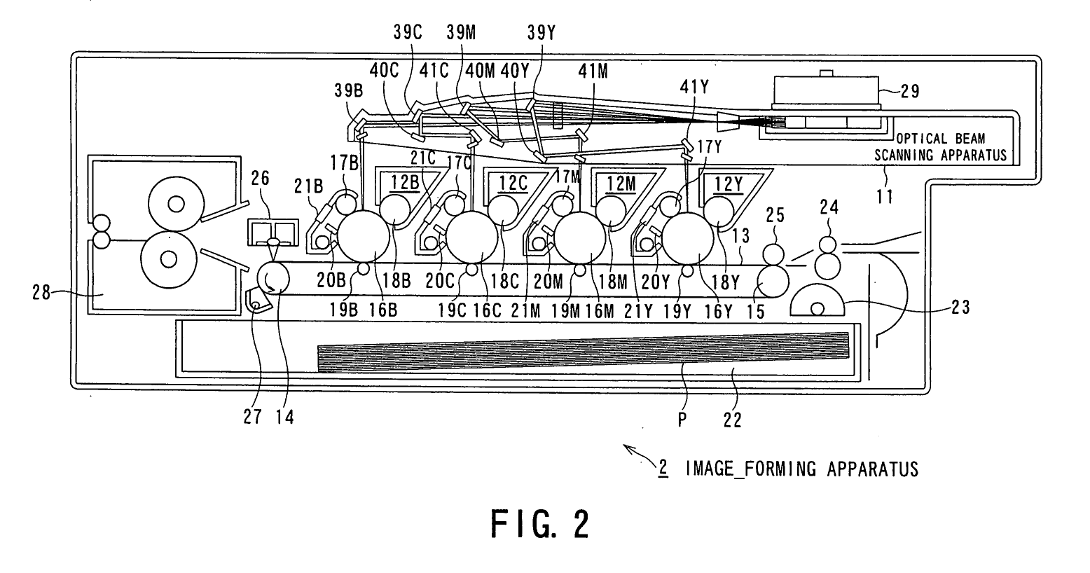

FIG. 2 shows the configuration of an image forming apparatus 2 incorporating an optical beam scanning apparatus 11 to which the present invention is applied. Because the image forming apparatus 2 normally uses four kinds of image data separated in colors for respective color components including Y (yellow), M (magenta), C (cyan), and B (black) and four sets of various devices used to form images of the respective color components corresponding to Y, M, C, and B, the image data for the respective color components and the corresponding devices are identified by appending capitals Y, M, C, and B as a suffix.

As is shown in FIG. 2, the image forming apparatus 2 includes first through fourth image forming portions 12Y, 12M, 12C, and 12B that form images of respective color components separated in colors.

The image forming portions 12 (12Y, 12M, 12C, and 12B) are disposed below the optical beam scanning apparatus 11 at the corresponding positions to which laser beams L (LY, LM, LC, and LB) of the respective color components are irradiated by a first post-deflection bending mirror 39B and third post-deflection bending mirrors 41Y, 41M, and 41C in the optical beam scanning apparatus 11 in order of the image forming portions 12Y, 12M, 12C, and 12B.

A carrying belt 13 that carries a recording sheet of paper P, onto which images formed individually by the image forming portions 12 (12Y, 12M, 12C, and 12B) are transferred, is disposed below the image forming portions 12 (12Y, 12M, 12C, and 12B).

The carrying belt 13 is pulled across a belt driving roller 14 rotated in the direction indicated by an arrow by an unillustrated motor and a tension roller 15, and is therefore rotated at a specific velocity in the direction in which the belt driving roller 14 is rotated.

The image forming portions 12 (12Y, 12M, 12C, and 12B) are formed in a cylindrical shape to be able to rotate in the direction indicated by the arrow, and respectively include photoconductive drums 16Y, 16M, 16C, and 16B on which electrostatic latent images corresponding to images exposed by the optical beam scanning apparatus 11 are formed.

On the periphery of the photoconductive drums 16 (16Y, 16M, 16C, and 16B), the following are disposed respectively in order in the direction in which the photoconductive drums 16 (16Y, 16M, 16C, and 16B) are rotated: charging devices 17 (17Y, 17M, 17C, and 17B) that confer specific potential to the surfaces of the photoconductive drums 16 (16Y, 16M, 16C, and 16B), developing devices 18 (18Y, 18M, 18C, and 18B) that develop the electrostatic latent images formed on the surfaces of the photoconductive drums 16 (16Y, 16M, 16C, and 16B) by supplying toners of the corresponding colors, transferring devices 19 (19Y, 19M, 19C, and 19B) that transfer toner images on the photoconductive drums 16 (16Y, 16M, 16C, and 16B) onto a recording medium, that is, a recording sheet of paper P, carried by the carrying belt 13, cleaners 20 (20Y, 20M, 20C, and 20B) that remove residual toner on the photoconductive drums 16 (16Y, 16M, 16C, and 16B), and static erasers 21 (21Y, 21M, 21C, and 21B) that remove residual potential remaining on the photoconductive drums 16 (16Y, 16M, 16C, and 16B) after the toner images are transferred.

The transferring devices 19 (19Y, 19M, 19C, and 19B) respectively oppose the photoconductive drums 16 (16Y, 16M, 16C, and 16B) from the back surface of the carrying belt 13 while the carrying belt 13 is present between the photoconductive drums 16 (16Y, 16M, 16C, and 16B) and the selves.

A paper cassette 22 accommodating recording sheets of paper P, on which images formed by the image forming portions 12 (12Y, 12M, 12C, and 12B) are transferred, is disposed below the carrying belt 13. Also, the cleaners 20 (20Y, 20M, 20C, and 20B) remove residual toner, respectively, on the photoconductive drums 16 (16Y, 16M, 16C, and 16B) that was not transferred when the toner images were transferred onto a recording sheet of paper P, respectively, by the transferring devices 19 (19Y, 19M, 19C, and 19B).

A feeding roller 23 that is formed almost in a semicircular shape and feeds recording sheets of paper P accommodated in the paper cassette 22 one by one from the top, on the side in close proximity to the tension roller 15 is disposed at one end of cassette 22.

Between the feeding roller 23 and the tension roller 15, a registration roller 24 that matches the top end of a single recording sheet of paper P taken out from the cassette 22 with the top end of the toner image formed on the photoconductive drum 16B in the image forming portion 12B (black) is disposed.

At the position in close proximity to the tension roller 15 between the registration roller 24 and the first image forming portion 12Y and substantially opposing the position on the outer periphery of the carrying belt 13 corresponding to the position at which the tension roller 15 and the carrying belt 13 come in contact with each other, an attraction roller 25 that confers a specific electrostatic attraction force to a single recording sheet of paper P carried at specific timing by the registration roller 24 is disposed.

In close proximity to one end of the carrying belt 13 and the belt driving roller 14 and substantially on the outer periphery of the carrying belt 13 that comes into contact with the belt driving roller 14, a first registration sensor 26a and a second registration sensor 26b that detect the position of an image formed on the carrying belt 13 or an image transferred onto a recording sheet of paper P are disposed spaced apart by a certain distance in the axial direction of the belt driving roller 14 (because FIG. 2 is a sectional front view, the first registration sensor 26a positioned ahead of the sheet surface is not shown).

At the position on the outer periphery of the carrying belt 13 that comes into contact with the belt driving roller 14 where a recording sheet of paper P carried by the carrying belt 13 will not come into contact, a carrying belt cleaner 27 that removes toner or paper dust from a recording sheet of paper P adhering on the carrying belt 13 is disposed.

In a direction in which a recording sheet of paper P carried by the carrying belt 13 is separated from the belt driving roller 14 and carried further, a fixing device 28 that fixes the toner image, which has been transferred onto the recording sheet of paper P, on the recording sheet of paper P is disposed.

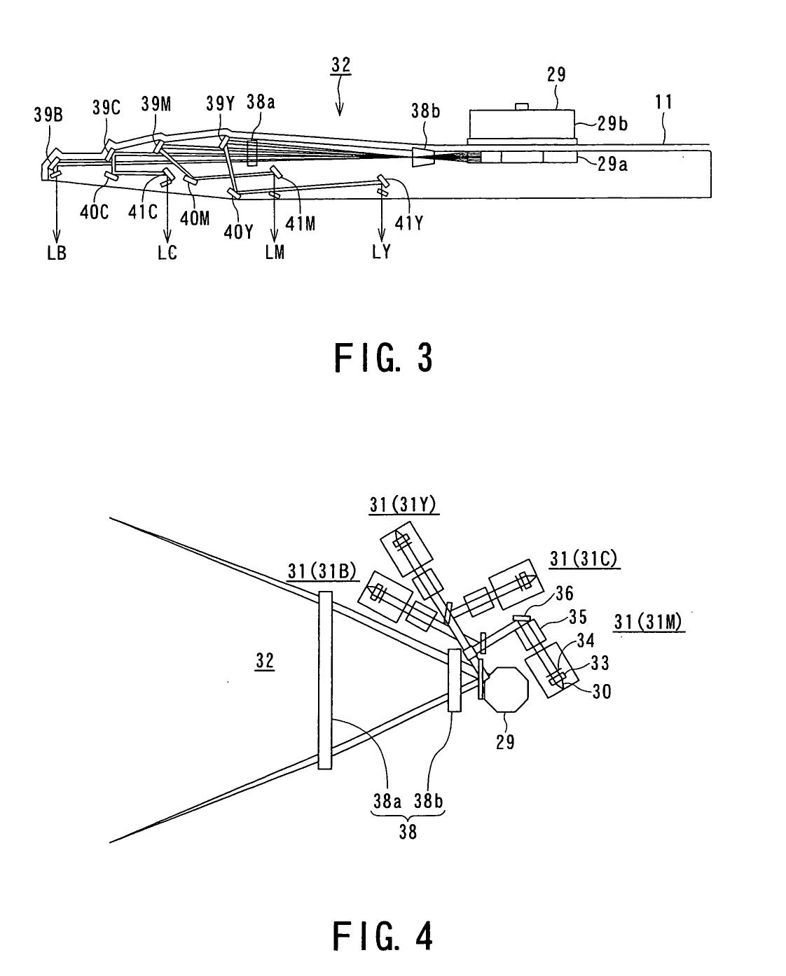

FIG. 3 and FIG. 4 show the configuration of the optical beam scanning apparatus 11 of FIG. 2 in detail.

The optical beam scanning apparatus 11 includes an optical deflector 29 comprising a polygonal mirror main body (so-called polygon mirror) 29a having, for example, eight plane reflecting surfaces (plane reflecting mirrors) disposed to form a regular polygon and a motor 29b that rotates the polygonal mirror main body 29a in the main scanning direction at a specific velocity, and light sources 30 (30Y, 30M, 30C, and 30B) that output optical beams, respectively, toward the first through fourth image forming portions 12Y, 12M, 12C, and 12B of FIG. 2.

The optical deflector 29 is deflection means for deflecting optical beams (laser beams) emitted from the light sources 30 (30Y, 30M, 30C, and 30B) toward the image planes disposed at the specific positions, that is, toward the outer peripheral surfaces of the photoconductive drums 16Y, 16M, 16C, and 16B in the first through fourth image forming portions 12Y, 12M, 12C, and 12B, respectively, at a specific linear velocity. In addition, pre-deflection optical systems 31 (31Y, 31M, 31C, and 31B) are disposed between the optical deflector 29 and the light sources 30 (30Y, 30M, 30C, and 30B), and a post-deflection optical system 32 is disposed between the optical deflector 29 and the image planes.

A direction in which the respective laser beams are deflected (scanned) by the optical deflector 29 is referred to as “main scanning direction”, and a direction orthogonal to both the main scanning direction and the axial line used as the reference of deflection operations provided to the laser beams by the optical deflector 29 for the laser beams scanned (deflected) by the optical deflector 29 to travel in the main scanning direction is referred to as “sub-scanning direction”.

As is shown in FIG. 4, the pre-deflection optical systems 31 respectively include light sources 30 (30Y, 30M, 30C, and 30B) comprising laser diodes and provided for respective color components, finite focusing lenses 33 (33Y, 33M, 33C, and 33B) that confer a specific focusing property to laser beams emitted from the light sources 30 (30Y, 30M, 30C, and 30B), apertures 34 (34Y, 34M, 34C, and 34B) that confer an arbitrary sectional beam shape to laser beams L having passed through the finite focusing lenses 33 (33Y, 33M, 33C, and 33B), and cylinder lenses 35 (35Y, 35M, 35C, and 35B) that further confer a specific focusing property in the sub-scanning direction to the laser beams L having passed through the apertures 34 (34Y, 34M, 34C, and 34B). They trim the sectional beam shape of laser beams emitted from the respective light sources 30 (30Y, 30M, 30C, and 30B) into a specific shape and then guide the leaser beams to the reflection surface of the optical deflector 29.

For a laser beam LC for cyan exiting from the cylinder lens 35C, the optical path is bent by a bending mirror 36C, after which it is guided to the reflection surface of the optical deflector 29 by traveling straight through an optical path combining optical component 37. For a laser beam LB for black exiting from the cylinder lens 35B, the optical path is bent by a bending mirror 36B, after which it is guided to the reflection surface of the optical deflector 29 by being reflected on the optical path combining optical component 37. A laser beam LY for yellow exiting from the cylinder lens 35Y passes by above the bending mirror 36C, after which it is guided to the reflection surface of the optical deflector 29 by traveling straight through the optical path combining optical component 37. For a laser beam LM for magenta exiting from the cylinder lens 35M, the optical path is bent by a bending mirror 36M for the laser beam LM to pass by above the bending mirror 36B, after which it is guided to the reflection surface of the optical deflector 29 by being reflected on the optical path combining optical component 37.

The post-deflection optical system 32 includes an fθ lens 38 (fθ lenses 38a and 38b) comprising a set of two lenses and used to optimize the shapes and the positions on the image planes of the laser beams L (Y, M, C, and B) deflected (scanned) by the polygonal mirror main body 29a, a horizontal synchronization detection photo-detector (not shown) that detects the respective laser beams L to match the horizontal synchronizations of the laser beams L (LY, LM, LC, and LB) having passed through the fθ lens 38 (fθ lenses 38a and 38b), a horizontal synchronization bending mirror (not shown) that bends the respective laser beams L toward the horizontal synchronization detection photo-detector, an optical path correction element (not shown) disposed between the horizontal synchronization bending mirror and the horizontal synchronization detection photo-detector to bring the laser beams L (LY, LM, LC, and LB) of the respective color components reflected on the horizontal synchronization bending mirror toward the horizontal synchronization detection photo-detector almost into agreement with the position of incidence on the detection surface of the horizontal synchronization detection photo-detector, and plural post-deflection bending mirrors 39Y, 40Y, and 41Y (yellow); 39M, 40M, and 41M (magenta); 39C, 40C, and 41C (cyan); and 39B (black) that guide the laser beams L (LY, LM, LC, and LB) of the respective color components exiting from the fθ lens 38 (fθ lenses 38a and 38b) to the corresponding photoconductive drums 16 (16Y, 16M, 16C, and 16B).

Incidentally, when rotary adjustment about the optical axis is performed while the optical beam scanning apparatus 11 and the image forming apparatus 2 are assembled, rotary adjustment about the optical axis is performed normally by making access to the light source (laser diode) from behind. This requires a space to allow access to the light source (laser diode) from behind to perform adjustment, and the units of the optical beam scanning apparatus 11 and the image forming apparatus 2 are undesirably increased in size.

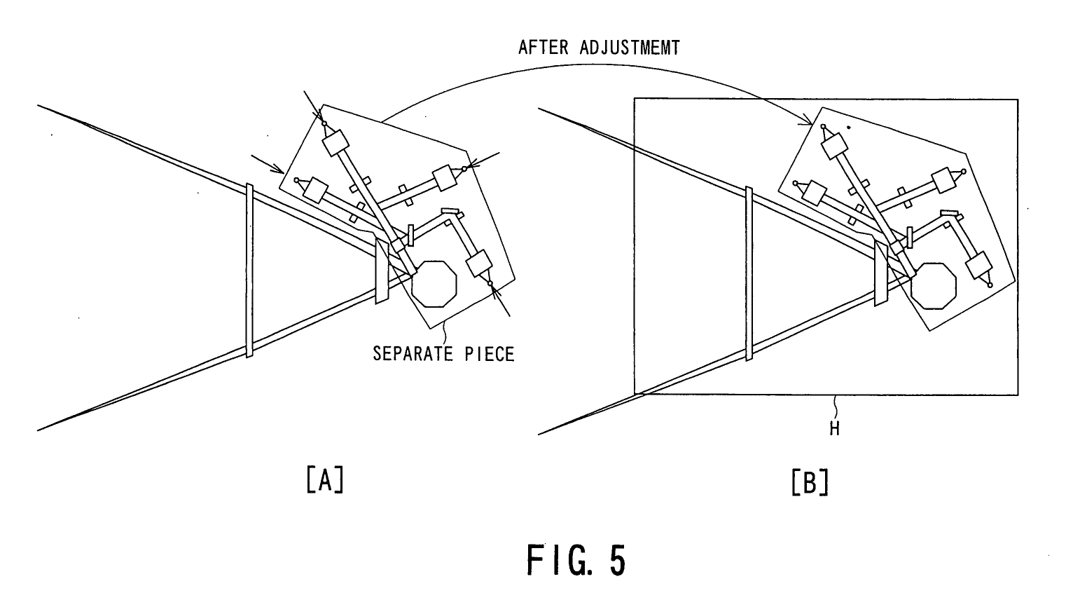

Such being the case, in the present invention, as is shown in FIG. 5A, a part of the optical units (the pre-deflection optical systems 31 or the post-deflection optical system 32) are made into a separate piece, and rotary adjustment of the light source is performed by an outside apparatus in the direction indicated by an arrow. Then, after the sub-scanning beam pitch on the photoconductive drum 16 is set to a specific value, as is shown in FIG. 5B, it is incorporated into a main body housing H of the optical beam scanning apparatus 11.

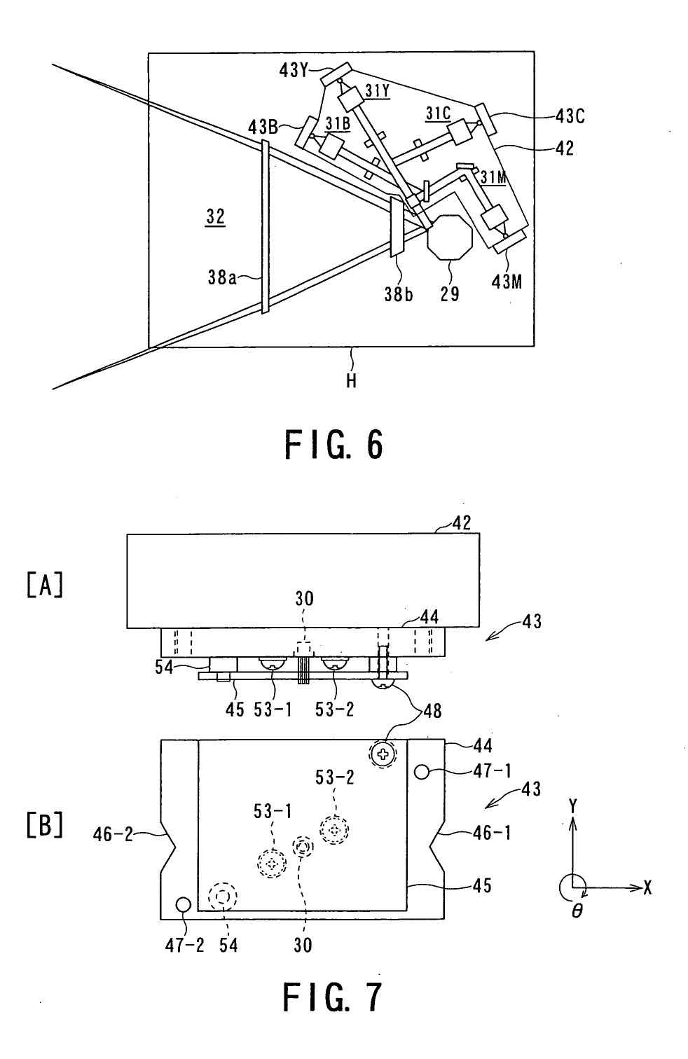

In a case where a part of components forming the optical unit are made into a separate piece, for example, as is shown in FIG. 6, the pre-deflection optical systems 31 (31Y, 31M, 31C, and 31B), that is, the light sources 30 (30Y, 30M, 30C, and 30B), the finite focusing lenses (collimator lenses) 33 (33Y, 33M, 33C, and 33B), the cylinder lenses 35 (35Y, 35M, 35C, and 35B), and the optical path combining optical component 37 are made into a separate piece and mounted on the same attaching plate 42.

In the case of the example of FIG. 6, holding members 43 (43Y, 43M, 43C, and 43B) respectively holding the light sources 30 (30Y, 30M, 30C, and 30B) are provided.

FIG. 7 shows the detailed configuration of the holding member 43 of FIG. 6. FIG. 7A is a plan view of the holding member 43 and FIG. 7B is a front view of the holding member 43.

The holding member 43 comprises a holder 44 that holds the corresponding light source 30, and a laser drive board 45 screwed to the holder 44.

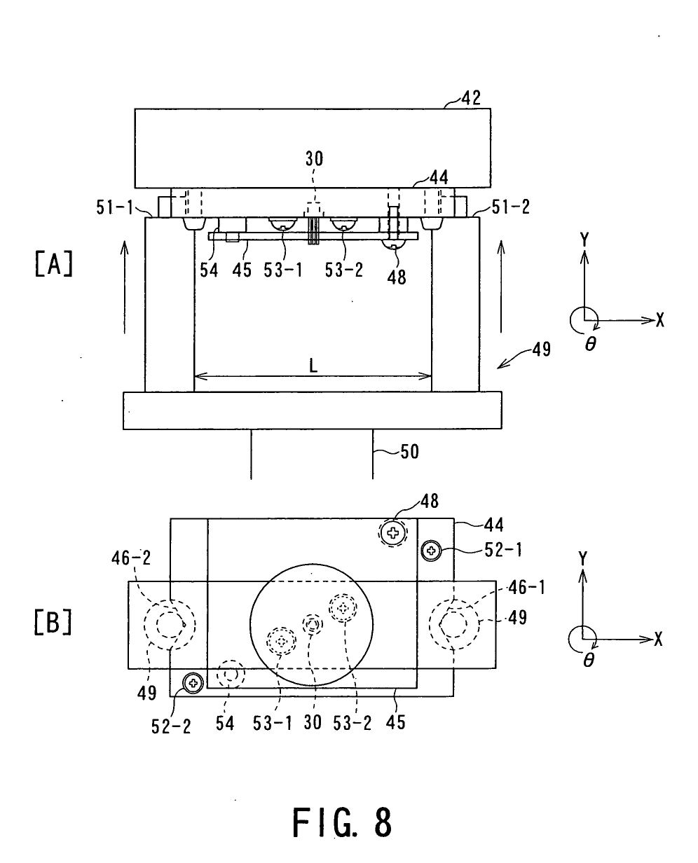

The holder 44 is provided with pinching portions 46-1 and 46-2 to pinch the holder 44 firmly when the outside apparatus (the outside apparatus 49 of FIG. 8) adjusts rotations of each light source 30 about the optical axis. Each light source 30 is disposed on a line linking these two pinching portions 46-1 and 46-2. It should be noted that each light source 30 is fixed by means of light source fixing screws 53-1 and 53-2.

Also, attachment holes 47-1 and 47-2 are made in the holder 44 at specific positions, and the holder 44 is fixed to the attaching plate 42 by inserting holder attaching screws (holder attaching screws 52-1 and 52-2 of FIG. 8) into the attachment holes 47-1 and 47-2.

The laser drive board 45 is positioned by a positioning protrusion 54 and fixed to the holder 44 with a laser drive board fixing screw 48.

The attachment holes 47-1 and 47-2 are designed to be slightly larger than the diameter of the screw for the holder attaching screws (the holder attaching screws 52-1 and 52-2 of FIG. 8). Accordingly, the rotary adjustment (angle θ) of each light source 30 about the optical axis and the optical axis adjustment (X direction and Y direction) with the collimator lens are enabled for a quantity comparable to the clearance thus secured. Furthermore, there is a clearance between the attachment holes (the attachment holes 47-1 and 47-2) and the holder attaching screws (the holder attaching screws 52-1 and 52-2), and a fixing position (X direction and Y direction) and a fixing angle (angle θ) of the holder are adjustable with respect to the holder attaching screws (the holder attaching screws 52-1 and 52-2).

FIG. 8 shows the configuration when the outside apparatus 49 is attached to the holding member 43.

FIG. 8A is a plan view when the outside apparatus 49 is attached to the holding member 43, and FIG. 8B is a front view when the outside apparatus 49 is attached to the holding member 43.

As are shown in FIGS. 8A and 8B, schematically, the outside apparatus 49 comprises an adjusting arm main body 50 that performs rotary adjustment of each light source 30 about the optical axis, and rods 51-1 and 51-2 attached to the holding member 43.

The rods 51-1 and 51-2 of the outside apparatus 49 are attached, respectively, to the pinching portions 46-1 and 46-2 of the holding member 43. At least one of these two rods 51-1 and 51-2 is extendable in the X direction, and the length L between the two rods 51-1 and 51-2 is therefore adjustable. This configuration allows the two rods 51-1 and 51-2 to apply a constant load on the holder 44.

The holder attaching screws 52-1 and 52-2 are temporarily screwed, respectively, into the attachment holes 47-1 and 47-2 made in the holder 44 to the extent that the outside apparatus 49 is able to adjust the holding member 43. In this instance, a required load is applied to the rods 51-1 and 51-2 in the optical axis direction of the light source 30.

The outside apparatus 49 has three degrees of freedom including the X direction, the Y direction, and the angle θ. By adjusting the holder 44 pinched between the rods 51-1 and 51-2 in the X direction and the Y direction and at the angle θ, not only is it possible to perform the optical axis matching with the collimator lens for the position of the laser beam to approximate to a specific pre-set value, but it is also possible to adjust rotations of each light source 30 about the optical axis. In addition, by making a part of components forming the optical system unit into a separate piece to perform rotary adjustment of each light source 30 about the optical axis by the outside apparatus 49, errors caused when adjustment is performed can be suppressed to only the error caused when the separate piece is incorporated into the optical beam scanning apparatus 11 or the image forming apparatus 2. It is thus possible to perform rotary adjustment of the light source about the optical axis with ease and at high accuracy to maintain a specific sub-scanning beam pitch on the photoconductive drum 16, even in a small space. Consequently, it is possible to prevent the units of the optical beam scanning apparatus 11 and the image forming apparatus 2 from being increased in size.

It should be noted that the center of rotation of the adjusting arm main body 50 of the outside apparatus 49 coincides with the center of the laser emission point of each light source 30. Accordingly, not only can the optical axis matching with the collimator lens be performed at high accuracy, but also rotations of each light source 30 about the optical axis can be adjusted at high accuracy.

When the optical axis matching with the collimator lens and the rotary adjustment of each light source 30 about the optical axis are completed by the outside apparatus 49, the holder attaching screws 52-1 and 52-2 used to fix the holder 44 are tightened, and the holder 44 is completely fixed to the attaching plate 42.

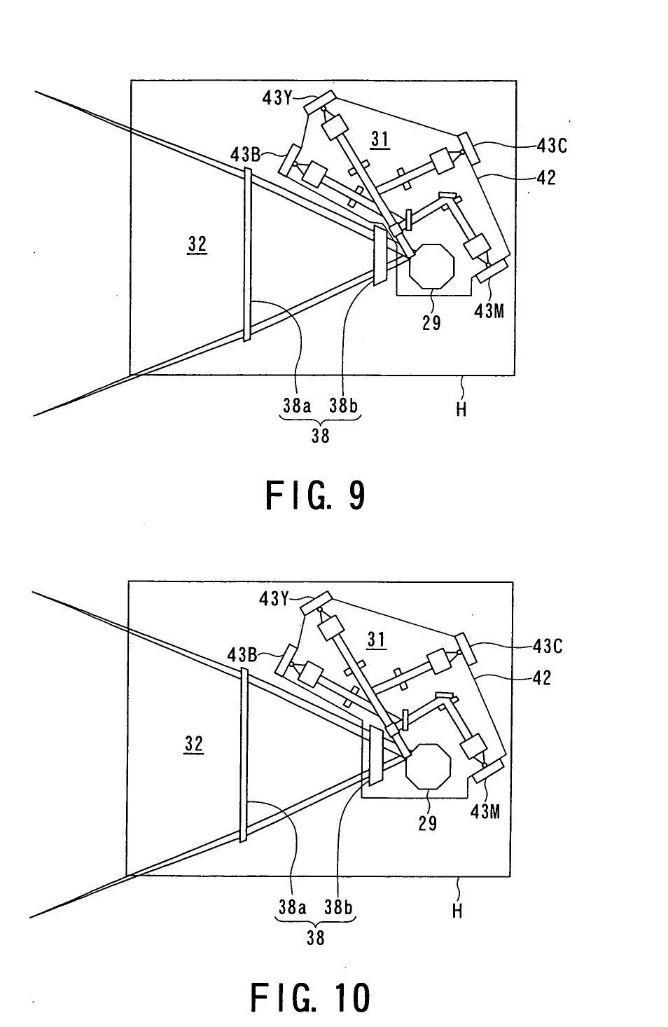

As is shown in FIG. 6, in the embodiment of present invention, the pre-deflection optical systems 31 (31Y, 31M, 31C, and 31B), that is, the light sources 30 (30Y, 30M, 30C, and 30B), the finite focusing lenses (collimator lenses) 33 (33Y, 33M, 33C, and 33B), the cylinder lenses 35 (35Y, 35M, 35C, and 35B), and the optical path combining optical component 37 are made into a separate piece and mounted on the same attaching plate 42. The present invention, however, is not limited to this case, and for example, as is shown in FIG. 9, besides the pre-deflection optical systems 31, the optical deflector 29 (the polygonal mirror main body (so-called polygon mirror) 29a and the motor 29b) may be further added to the separate piece and mounted on the same attaching plate 42. By adopting the arrangement shown in FIG. 6, it is possible to forestall an influence of heat generated while the polygonal mirror main body 29a is rotating during printing or the like.

Alternatively, as is shown in FIG. 10, besides the pre-deflection system 31 and the optical deflector 29, for example, the fθ lens 38b of the post-deflection optical system 32 may be further added to the separate piece and mounted on the same attaching plate 42. It goes without saying that both the fθ lenses 38a and 38b of the post-deflection optical system 32 may be added to the separate piece and mounted on the same attaching plate 42.

By adopting the arrangement as shown in FIG. 10, it is possible to lessen errors caused when the separate piece is incorporated into the optical beam scanning apparatus 11 or the image forming apparatus 2.

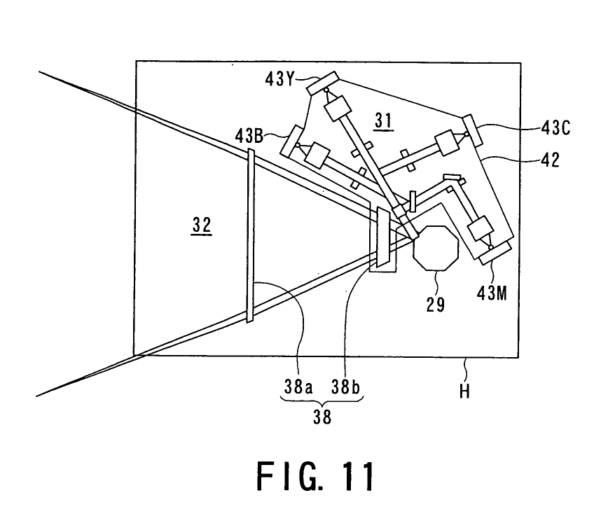

Further, as is shown in FIG. 11, besides the pre-deflection optical system 31, for example, the fθ lens 38b of the post-deflection optical system 32 may be further added to the separate piece and mounted on the same attaching plate 42. It goes without saying that both the fθ lenses 38a and 38b of the post-deflection optical system 32 may be added to the separate piece and mounted on the same attaching plate 42.

What is claimed is:

1. An optical beam scanning apparatus using plural light sources, comprising:
a main body housing;
an attaching plate attached to the main body housing;
a holder attached to the attaching plate by means of attaching screw; and
a laser drive board secured to the holder by means of screws,
wherein the holder is provided with plural pinching portions for pinching the holder by an external apparatus and an attachment hole used to attach the holder to the attaching plate, and the holder is adjustable, in a fixing position thereof, with respect to the attaching screw.

2. The optical beam scanning apparatus according to claim 1, wherein:
at least a pre-deflection optical system is mounted on the attaching plate.

3. The optical beam scanning apparatus according to claim 1, wherein:
at least a pre-deflection optical system and an optical deflector are mounted on the attaching plate.

4. The optical beam scanning apparatus according to claim 1, wherein:
at least a pre-deflection optical system, an optical deflector, and a post-deflection optical system are mounted on the attaching plate.

5. The optical beam scanning apparatus according to claim 1, wherein:
at least a pre-deflection optical system and a post-deflection optical system are mounted on the attaching plate.

6. The optical beam scanning apparatus according to claim 1, wherein:
in the holder, a corresponding light source is held on a line liking two pinching portions among the plural pinching portions provided to the holder.

7. An image forming apparatus equipped with an optical beam scanning apparatus using plural light sources, wherein the optical beam scanning apparatus comprises:
a main body housing;
an attaching plate attached to the main body housing;
a holder attached to the attaching plate by means of attaching screw; and
a laser drive board secured to the holder by means of screws,
wherein the holder is provided with plural pinching portions for pinching the holder by an external apparatus and an attachment hole used to attach the holder to the attaching plate, and the holder is adjustable, in a fixing position thereof, with respect to the attaching screw.
